(19) United States
(12) Patent Application Publication
(10) Pub. No.: US 2007/0039438 A1
(43) Pub. Date: Feb. 22, 2007

(54) THERMOPLASTIC MATERIAL CUTTING MACHINE

(76) Inventors: Andrew James Lineberry, Bailey, CO (US); Michael William Tobin, Bozeman, MT (US)

Correspondence Address: BLACKWELL SANDERS PEPER MARTIN LLP, 4801 Main Street, Suite 1000, KANSAS CITY, MO, 64112, US

(21) Appl. No.: 11/161,864

(22) Filed: Aug. 19, 2005

(51) Int. Cl. B26D 1/553

(52) U.S. Cl. 83/16; 83/171; 83/651.1

(57) ABSTRACT

The present invention is directed to an apparatus for cutting synthetic materials. The apparatus comprises a frame having a platform, with a block magazine, a cutting mechanism and a means for discharging cut block sections of material from the platform. The block magazine is mounted to the frame and positions the synthetic materials for cutting. The cutting mechanism provides a cut pattern in the materials and is moveable between a first position and a second position, proximal and distal to the platform, respectively. The apparatus further comprises automated components and control mechanisms for moving cut material and controlling the cutting mechanism.

### CROSS-REFERENCE TO RELATED APPLICATIONS

None.

### STATEMENT REGARDING FEDERALLY SPONSORED RESEARCH OR DEVELOPMENT

Not Applicable.

### BACKGROUND OF THE INVENTION

Thermoplastic materials, such as expanded molded or extruded polystyrene, polystyrene/polypropylene compounds, polystyrene/polyethylene compounds, or thermoplastic materials with similar physical properties, have become popular for use as packaging filler to provide stability and cushioning to items during shipment and handling. More particularly, thermoplastic materials formed as small pellets and having a variety of shapes are known to be particularly useful because of the ability of the pellets to substantially fill voids around items placed in a package or other container.

Applicants' co-pending application entitled “System For Cutting And Wrapping Thermoplastic Materials”, filed Aug. 19, 2005, the teachings of which are incorporated herein by reference, describes a process whereby a thermoplastic material block is cut in two directions to generate waveform strips and then automatically wrapped to secure the strips together such that the block in “pre-cut” form substantially retains its original geometric form.

### BRIEF SUMMARY OF THE INVENTION

A thermoplastic material cutting machine of the present invention is configured to position pre-cut and wrapped thermoplastic blocks to undergo cutting in a direction orthogonal to at least one of the previous cuts made to a given block, and to discharge the sectioned, pre-wrapped blocks for packaging and/or shipping. In this way, a final packaging filler pellet shape (e.g., wave pellet) may be formed without disassembling the pellets from the intact, wrapped block section. The cutting machine thereby provides a packing filler product that may be packaged and transported to a location where items are to be packed in a container, and then the one or more wrapped, block section may be disassembled into the individual pellets within the container to surround the item to provide cushioning and stability to same. By maintaining the wrapped block sections as a sub-set of the original geometric form of the pre-cut and wrapped thermoplastic block, a product is formed that has significantly less bulk as compared to loose pellet pieces. Thus, it is easier and more cost effective to ship the block sections to a location where they are needed as packaging filler as opposed to shipping a bag or other container of loose pellet pieces.

In one aspect, a block magazine sequentially positions the pre-cut and wrapped blocks loaded thereon and dispenses individual blocks onto a platform as needed for positioning in a cutting region of the polystyrene cutting machine. A cutting mechanism located at a first position beneath the block placed on the platform is then raised and moved through the pre-cut and wrapped block to a second position, thereby producing a cut pattern in the block generally orthogonal to at least one of the previous two cuts formed in the pre-cut and wrapped block prior to the block being loaded with the cutting machine of the present invention. An automated armature then advances down the platform to discharge the now sectioned, pre-cut block out of the cutting region onto a receiving table where the block sections may be, for example, packaged together for shipping and/or storage. Once the sectioned, pre-cut block has been fully discharged, the cutting mechanism is then lowered back to the first position, and the block magazine releases another pre-cut and wrapped block onto the platform for another cutting cycle.

In another aspect, the cutting mechanism comprises a cutting harp formed of a series of spaced, parallel arranged electrically heated wires mounted with a frame. The cutting harp is coupled with a drive system to accomplish the raising and lowering of the harp to perform the cutting to form the pre-cut and wrapped block into block sections.

In yet another aspect, a control unit is provided which may regulate, for example, the speed of the cutting motion by the cutting mechanism, the temperature of the electrically heated wires, and the sequential positioning of pre-cut blocks by the block magazine. The control unit may also control the raising and lowering of a discharge door separating the platform from the receiving table.

### BRIEF DESCRIPTION OF THE SEVERAL VIEWS OF THE DRAWING

FIG. 1 is a perspective view of the thermoplastic material cutting machine of the present invention;

FIG. 2 is a perspective view of the pre-cut block before and after being cut into a number of sections by the cutting mechanism of the cutting machine;

FIG. 3 is a schematic block diagram of the control unit;

FIG. 4 is a left side elevational view of the cutting machine of FIG. 1;

FIG. 5 is a right side elevational view of the cutting machine of FIG. 1;

FIG. 6A is a close-up view of the block indexing mechanism where the support bar holds the pre-cut block at a first position; FIG. 6B is a close-up view of the block indexing mechanism where the support bar is at a second position where the pre-cut block is released;

FIG. 7 is a front elevational view of the cutting machine of FIG. 1; and

FIG. 8 is a front elevational view of the cutting machine of FIG. 1 showing the cutting mechanism sectioning the pre-cut block.

### DETAILED DESCRIPTION OF THE INVENTION

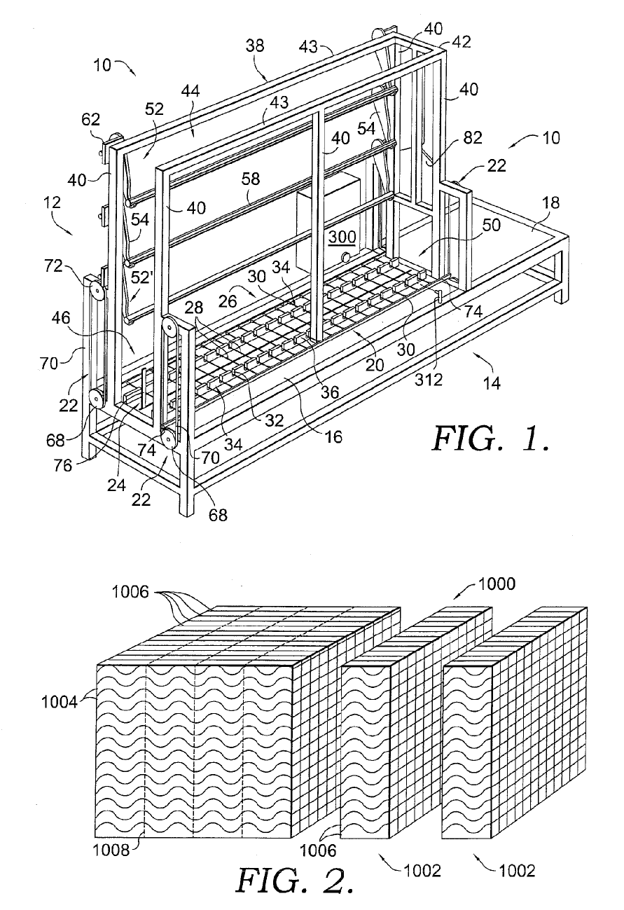

With specific reference to the several views of the drawing, where like numerals designate like elements, there is shown in FIG. 1 a cutting machine 10 configured for cutting pre-cut and wrapped blocks 1000 of thermoplastic material. Thermoplastic material includes expanded molded or extruded polystyrene, polystyrene/polypropylene compounds, polystyrene/polyethylene compounds, or other synthetic materials with similar physical properties. The blocks 1000 that are to be cut by the cutting machine 10 are preferably pre-fabricated in accordance with the teachings of the patent application entitled “System For Cutting And Wrapping Thermoplastic Materials”, filed on Aug. 19, 2005 by the same Applicants as the present application.

As seen in FIG. 2, the cutting performed by the cutting machine 10 to the pre-cut blocks 1000 along cutting lines 1008 is generally in a transverse or orthogonal direction to pre-existing cutting lines 1005. The cutting machine 10 divides the block 1000 into component sections 1002, forming elongate waveform strips 1004 that make up each pre-cut block 1000 into individual subcomponent wave pellets 1006 of a specified length. Additionally, the cutting only compromises the integrity of the strap wrapping around the pre-cut blocks 1000 locally at the cutting lines 1008; the wrapping remains intact around the perimeter of the sections 1002 so as to retain the pellets 1006 of each section 1002 together and substantially maintain the transverse cross-sectional quadrilateral (e.g., square or rectangular) shape of the section 1002. By maintaining the pellets 1006 together in the section 1002, as opposed to breaking the section apart (e.g., by cutting the strap wrapping or pushing on the section 1002 with sufficient longitudinal force to move the pellets 1006 relative to one another), the section 1002 may be more easily stored and/or transported to a location where the section 1002 may be disassembled into the constituent pellets 1006 needed for use as packaging filler.

With reference again to FIG. 1, the cutting machine 10 includes a block magazine 12 for sequentially positioning of pre-cut blocks 1000, a machine frame 14 including a platform 16 and a receiving table 18, a cutting mechanism 20 for sectioning the pre-cut block 1000 into component sections 1002, a drive system 22 for moving the cutting mechanism 20 as needed to perform the sectioning, and an automated armature 24 for discharging the sections 1002 from a cutting region 26 of the machine 10 onto the receiving table 18. The discharged block sections 1002 may be packaged together for storage and/or shipment to a location where the pellets 1006 are needed for use.

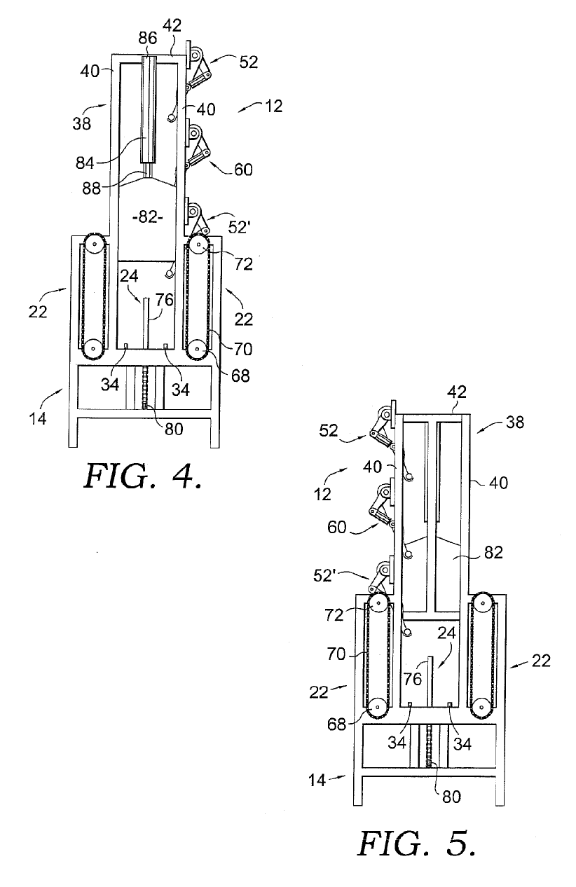

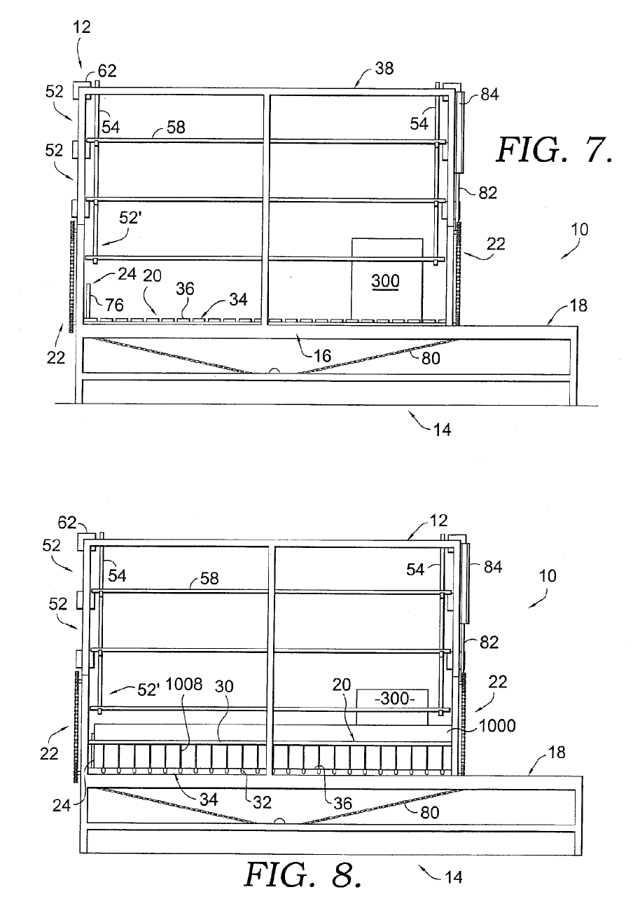

In one embodiment the cutting mechanism 20 comprises a cutting harp having spaced, parallel arranged electrically heated wires 28 spanning transversely relative to the platform 16 and connected with a conductive harp frame 30 that delivers, through conductive wires (not shown) connected with an electrical source, an electrical current value that is established by a control unit 300. The electrical current value is selected to give the electrically heated wires 28 a sufficiently high temperature to efficiently and smoothly cut through the pre-cut block 1000 to form component sections 1002. The harp frame 30 is connected with the drive system 22 that moves the cutting harp 20 in the vertical direction, also seen in FIGS. 4-8. For example, the drive system 22 may move the harp 20 upward from a first position shown in FIG. 1where the harp 20 is proximal to the platform 16, to section a pre-cut block 1000 positioned on the platform 16 over the harp 20, to a second position where the harp 20 is distal to the platform 16. For instance, upward harp 20 movement to cut block 1000 into sections 1002 is depicted in FIG. 8. Then, upon the block sections 1002 being discharged from the platform 16 out of the cutting region 26 by the automated armature 24, the drive system 22 lowers the harp 20 from the second position back to the first position in preparation for another block 1000 to be sectioned. When the harp 20 is in the first position, the wires 28 may rest within notched areas 32 of a pair of thermally insulative rails 34 mounted onto the platform 16. Thus, a series of raised members 36 of the rails 34 may support the pre-cut block 1000 when the block is positioned on the platform 16. Preferably, the rails 34 are formed of a material that can withstand the high temperatures imposed thereon by the wires, such as a composite material (e.g., a ceramic).

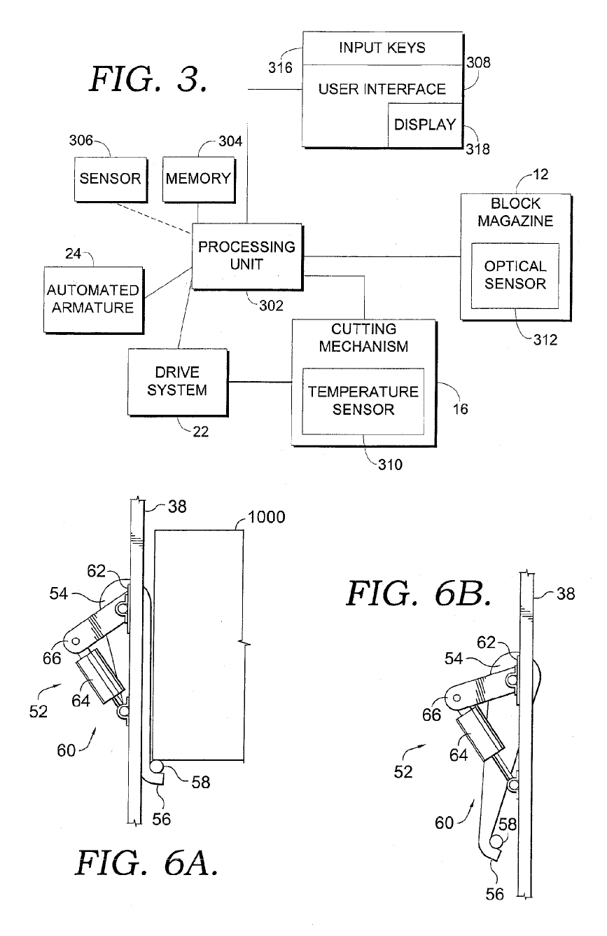

Electromechanical operation of the cutting machine 10 is schematically illustrated in FIG. 3. The control unit 300 includes a processing unit 302 (e.g., microprocessor and logic circuitry) for controlling the operation of one or more of the block magazine 12, the cutting mechanism 20, the drive system 22 for the cutting mechanism, and the automated armature 24, and internal system memory 304 (e.g., EEPROM) coupled with, or integrated into, the processing unit 302 and upon which is stored an application program to control operation of the block magazine 12, the cutting mechanism 20, the drive system 22 and the automated armature 24 based upon data received from various sensors 306 and a user interface 308. In one exemplary arrangement, a temperature sensor 310 measures the temperature of the electrically heated wires 28 of the cutting harp 20 to ensure that the wires can efficiently cut through the pre-cut block 1000. In another exemplary arrangement, an optical sensor 312 determines whether one pre-cut block 1000 is presently located on the platform 16 (i.e., by sensing whether block 1000 is in the optical path of the sensor 312) and if not, the processing unit 302 commands the block magazine 12 to position one pre-cut block 1000 on the platform 16 so that sectioning thereof may begin. The temperature sensor 310 and/or the optical sensor 312 may provide data to the processing unit 302 through an analog-to-digital (A/D) converter (not shown) if the sensors drive an analog signal. One practical partitioning of the components of the control unit 300 is to place the processing unit 302, system memory 304 and the A/D converter, if needed, within control unit formed as a control box 300. Additionally, the user interface 308 positioned on the housing of the control box 300 may have input keys 316 where, for example, commands are input for the desired through-put of pre-cut blocks 1000, and a display 318 showing various data to the user (e.g., selected speed of block sectioning, temperature reading for the electrically heated wires 28, etc.)

The block magazine 12, best seen in FIGS. 1, 4, 5, 6A and 6B, is positioned generally above the platform 16. Block magazine 12 has a magazine frame 38 including vertical members 40, a transverse upper cross-member 42 interconnecting vertical members 40, and longitudinal upper cross-members 43 interconnecting vertical members 40, thereby defining a channel 44 into which may be placed pre-cut blocks 1000. An open end of the channel 44 is located above an input end 46 of the platform 16 signifying one direction in which pre-cut blocks 1000 may be loaded into magazine 12. A closed-end 48 of the channel 44 near upper cross-member 42 is located above an output end 50 of the platform 16 where block 1000 cut into sections 1002 may be discharged from the platform 16.

The magazine frame 38 is supported by the machine frame 14. The block magazine 12 includes at least two rows of block indexing mechanisms 52 that stack the pre-cut blocks 1000 within the channel 44 prior to being sectioned by the cutting mechanism 20. Each block indexing mechanism 52 is shown in particular detail in FIGS. 6A and 6B, and includes swing arms 54 pivotably mounted with the magazine frame 38, a support bar 58 extending between adjacent swing arms 54, and a rotation control mechanism 60 to cause the swing arms 54 to selectively rotate in one of two directions. Each swing arm 54 has a lower hook 56 for engaging the support bar 58.

One rotation control mechanism 60 may be provided for each swing arm 54, or preferably, multiple swing arms 54 are rigidly connected together through the support bar 58, such that only one rotation control mechanism 60 may be needed per pair of wing arms 54. Pivotable mounting of the swing arms 54 to the magazine frame 38 is accomplished through mounting plates 62 affixed to the frame 38. As shown in FIGS. 4-6B, the rotational control mechanism 60 preferably takes the form of an air or pneumatic cylinder 64 pivotably mounted on one end with the magazine frame 38 and on an opposed end with a linkage 66 which is fixedly mounted with one swing arm 54.

In the extended position shown in FIG. 6A, the rotational control mechanism 60 rotates the swing arms 54 to a first position where the support bar 58 underlies the pre-cut block 1000 stacked thereon and supports the block. When the cutting machine 10 senses (e.g., through optical sensor 312) that the cutting mechanism 20 is ready to accept a new pre-cut block 1000, the control unit 300 instructs the rotational control mechanism 60 to rotate the swing arms 54 to a second position shown in FIG. 6B. At the second position, the support bar 58 is no longer positioned under the block 1000, allowing block 1000 to fall by the force of gravity either to a lower-mounted block indexing mechanism 52′ or onto platform 16 of the machine frame 14 for positioning of the block 1000 within the cutting region 26 for making the sectioning cut by the cutting mechanism 20. After the swing arms 54 have been in the second position for a certain amount of time, the arms return to the first position to accept another pre-cut block 1000 dropped from one block indexing mechanism 52 immediately thereabove.

The drive system 22 for the cutting harp 20, seen in FIGS. 1, 4, 5, 7 and 8, includes drive pulleys 68 each connected via a drive chain 70 with a driven pulley 72, and vertically aligned with one another such that attachment of longitudinal ends 74 of the harp frame 30 with the chain 70 cause the harp 20 to move vertically up and down. The driven pulley 72 is rotatably mounted onto the frame 14 and the drive pulley 68 is coupled with an output shaft of a motor (not shown). The automated armature 24 includes a rod 76 moving within a longitudinal slot 78 in the platform 16 and connected with a sub-platform chain 80 driven by a motor (not shown). FIGS. 1, 4 and 5 also show an exit door 82 slidably mounted with the magazine frame 38 above the output end 50 of the platform 16, to guard against a user handling materials on the receiving table 18 accidentally touching the cutting harp 20. Vertical sliding movement of the exit door 82 is accomplished by a lifting mechanism 84, such as an air or pneumatic cylinder, connected with the door 82 and controlled by the control unit 300. The lifting mechanism 84 is rigidly mounted on an upper end 86 thereof with the upper cross-member 42 and on a lower end 88 thereof with the exit door 82.

In use, a desired number of pre-cut blocks 1000 are loaded into the block indexing mechanisms 52 of the block magazine 12. Upon receiving commands from the user on the user interface 308, the control unit 300 instructs the lower, mounted block indexing mechanism 52 to dispense a pre-cut block 1000 positioned thereon onto the platform 16, and the upper block indexing mechanisms 52 to dispense pre-cut blocks 1000 positioned thereon (if any) onto the block indexing mechanism 52 immediately therebelow. At this point, the rod 76 of the automated armature 24 is positioned at the input end 46 of the platform 16 in preparation for pushing against the pre-cut block 1000 after cutting. Then, the cutting harp 20 may be moved vertically upward through the cutting region 26 by the drive system 22, as shown in FIG. 8, to section the pre-cut block 1000. Each block section 1002 rests on the raised members 36 of the insulated rails 34. Once the cutting harp 20 has moved completed through the pre-cut block 1000, and at a point vertically higher than the height of the rod 76, the exit door 82 is raised from a position blocking the output end 50 of the platform 16 and the sub-platform chain 80 drives the rod 76 towards the output end 50 to discharge the block sections 1002 onto the receiving table 18 out of the cutting region 26. Once the rod 76 has reached the output end 50 and the sections 1002 are fully discharged, the rod 76 is moved back to platform input end 46, the exit door 82 is lowered to cover the output end 50, and the cutting harp 20 is lowered back onto the isulated rails 34 such that another cycle of pre-cut block sectioning may begin.

Thus, the cutting machine 10 of the present invention provides an automated process for sectioning of pre-cut thermoplastic material blocks 1000 to form a component section 1002 that may be easily stored and shipped to a located where it is needed later and disassembled into constituent pellets 1006 product. Since certain changes may be made in the above apparatus and methods without departing from the scope hereof, it is intended that all matter contained in the above description or shown in the accompanying drawing be interpreted as illustrative and not in a limiting sense. It is also to be understood that the following claims are to cover certain generic and specific features described herein.

What is claimed is:

1. An apparatus for cutting blocks of synthetic material, comprising:
a frame having a platform;
a block magazine mounted with the frame for sequentially positioning the synthetic blocks relative to the platform;
a cutting mechanism coupled to the frame and vertically movable from a first position where the cutting mechanism is proximal to the platform and a second position where the cutting mechanism is distal to the platform, whereby movement of the cutting mechanism between the first position and the second position produces a cut pattern in the synthetic block positioned on the platform by the block magazine to divide the block into sections; and
means for discharging the block sections from the platform.

2. The apparatus of claim 1, wherein the synthetic material comprises a thermoplastic material.

3. The apparatus of claim 1, wherein the block magazine comprises:
at least two rows of block indexing mechanisms, each mechanism including,
at least two swing arms pivotably mounted with the frame,
a rotation control mechanism for selectively rotating the swing arms relative to the frame, and
a support bar extending between at least two swing arms for supporting a synthetic block thereon when the swing arms are in a first position.

4. The apparatus of claim 1, wherein the cutting mechanism comprises a cutting harp including generally parallel, spaced apart heated wires mounted onto a frame, the apparatus further comprising:
means for vertically moving the cutting harp between the first position and the second position.

5. The apparatus of claim 4, wherein the means for vertically moving comprises a drive system coupled with a motor, each drive system including:
one or more drive pulleys;
one or more driven pulleys;
a drive chain extending between the one or more drive pulleys and the one or more driven pulleys and connected with the cutting harp frame.

6. The apparatus of claim 1, further comprising a control means to selectively control the rate of movement of the cutting mechanism from the first position to the second position, and returning from the second position and the first position.

7. The apparatus of claim 1, wherein the platform has an input end and a discharge end, and wherein the means for discharging comprises:
an automated armature connected with a drive means to move the automated armature along a longitudinal track of the platform from the input end towards the discharge end to push the block sections out of the discharge end.

8. The apparatus of claim 7, further comprising a control means to selectively control the rate of movement of the automated armature from the input end to the discharge end, and returning from the discharge end to the input end.

9. An apparatus for cutting blocks of synthetic material, comprising:
a platform having an input end, a discharge end, and a longitudinal track extending therebetween;
a cutting mechanism movably positioned above the platform between a first position where the cutting mechanism is proximal to the platform and a second position where the cutting mechanism is distal to the platform, whereby movement of the cutting mechanism between the first position and the second position produces a cut pattern in the synthetic block positioned on the platform by the block magazine to divide the block into sections; and
an automated armature moveable along the longitudinal track of the platform from the input end towards the discharge end to push the block sections out of the discharge end.

10. The apparatus of claim 9, further comprising:
a block magazine positioned above the platform for sequentially positioning the synthetic blocks relative to the platform, the block magazine including:
a magazine frame; and
one or more block indexing mechanisms mounted with the magazine frame;
whereby each block indexing mechanism assumes a first position to support at least one synthetic block thereon and a second position to release the at least one synthetic block onto one of the platform or another lower positioned block indexing mechanism.

11. The apparatus of claim 9, wherein the cutting mechanism comprises a cutting harp including generally parallel, spaced apart heated wires mounted onto a frame, the apparatus further comprising:
means for vertically moving the cutting harp between the first position and the second position.

12. The apparatus of claim 11, wherein the-means for vertically moving comprises a drive system coupled with a motor, each drive system including:
one or more drive pulleys;
one or more driven pulleys;
a drive chain extending between the one or more drive pulleys and the one or more driven pulleys and connected with the cutting harp frame.

13. The apparatus of claim 9, further comprising a control means to selectively control the rate of movement of the cutting mechanism from the first position to the second position, and returning from the second position to the first position.

14. The apparatus of claim 9, wherein the platform has an input end and a discharge end, and wherein the means for discharging comprises:
an automated armature connected with a drive means to move the automated armature along a longitudinal track of the platform from the input end towards the discharge end to push the block sections out of the discharge end.

15. The apparatus of claim 14, further comprising a control means to selectively control the rate of movement of the automated armature from the input end to the discharge end, and returning from the discharge end to the input end.

16. A method of fabricating sections of synthetic material that when disassembled, form a plurality of pellets having a defined shape, the method comprising:
receiving, on a platform, a block of the synthetic material pre-cut into elongated strips and wrapped to maintain the strips together in substantially the original geometric form of the block prior to the formation of the strips; and
cutting the pre-cut block so as to form the pre-cut block into sections of a predefined length, each section formed with pellets that are subcomponents of the elongated strips.

17. The method of claim 16, wherein the step of receiving the synthetic block comprises:
the platform receiving the pre-cut block from a block magazine positioned above the platform for sequentially positioning one or more of the pre-cut blocks relative to the platform, the block magazine including:
a magazine frame; and
one or more block indexing mechanisms mounted with the magazine frame;
whereby each block indexing mechanism assumes a first position to support at least one pre-cut block thereon and a second position to release at least one pre-cut block onto one of the platform or another lower positioned block indexing mechanism.

18. The method of claim 16, wherein the step of cutting the pre-cut block comprises:
moving a cutting harp comprised of spaced, parallel arranged heated wires mounted onto a frame between a first position where the cutting mechanism is proximal to the platform and a second position where the cutting mechanism is distal to the platform, whereby movement of the cutting mechanism between the first position and the second position produces a cut pattern in the pre-cut block positioned on the platform.

19. The method of claim 16, wherein the platform has an input end and a discharge end, and wherein the method further comprising the step of:
discharging the sections of the pre-cut block from the platform moving in a direction from the input end to the discharging end.
